(19) United States
(12) Patent Application Publication
(10) Pub. No.: US 2017/0079112 A1
(43) Pub. Date: Mar. 16, 2017

(54) Multi-Stage Led Driving Circuit Capable of Eliminating Current Undershoot

(71) Applicant: Luxmill Electronic Co., Ltd., Zhubei City (TW)

(72) Inventors: Mao-Feng Lan, Zhubei City (TW); Tien-Pao Lee, Zhubei City (TW); Hsin-Hen Peng, Zhubei City (TW)

(73) Assignee: Luxmill Electronic Co., Ltd., Zhubei City (TW)

(21) Appl. No.: 15/006,979

(22) Filed: Jan. 26, 2016

(30) Foreign Application Priority Data
Sep. 11, 2015 (TW) 104214785

(51) Int. Cl. H05B 33/08

(52) U.S. Cl. CPC H05B 33/0887; H05B 33/083; H05B 33/0842

(57) ABSTRACT

A multi-stage LED driving circuit capable of eliminating current undershoot, including: an LED module having a plurality of stage output terminals; a plurality of switch units coupled with the stage output terminals to receive a plurality of branch currents and provide a plurality of current sensing signals; a current regulation circuit, having a control end coupled with a variable reference voltage, and a current path for receiving the branch currents; and a control unit, receiving the current sensing signals and a voltage signal at an input terminal of the current path, and controlling the switch units; wherein, the control unit uses every two adjacent signals of the current sensing signals to get a ratio in turn to determine whether to switch off a corresponding switch unit of the switch units after a deferred time, and uses the voltage signal to determine whether to change the deferred time.

### BACKGROUND OF THE INVENTION

Field of the Invention

The present invention relates to an LED (light emitting diode) driving circuit, especially to a multi-stage LED driving circuit capable of eliminating current undershoot.

Description of the Related Art

General multi-stage LED driving circuits are capable of providing a dynamic load having different numbers of LEDs for different levels of a line voltage, and operate in a way that a corresponding number of threshold voltages are predetermined according to stages of LEDs, and the number of LEDs included in the dynamic load is changed when the line voltage crosses one of the threshold voltages.

However, as the current-voltage characteristic curves of the LEDs are likely different, therefore, the predetermined threshold voltages are not likely suitable for different samples of the LED module. In other words, as randomly selected LEDs tend to have different forward voltage drops under a same operation current, therefore it is possible that one of the predetermined threshold voltages happens to be lower than a total forward voltage drop of a corresponding stage of LEDs, causing the multi-stage LED driving circuit to drive the dynamic load with the line voltage at an insufficient level, and thereby resulting in a phenomena of current undershoot. Please refer to FIG. 1, which illustrates corresponding waveforms of a line voltage and a load current of a multi-stage LED driving circuit of prior art. As illustrated in FIG. 1, when a line voltage V_{IN} crosses threshold voltages V₁, V₂, and V₃, a load current I_{L} generates current undershoots U₁, U₂, and U₃. As the phenomena of current undershoot can cause flickers to threaten the health of users, this is indeed a problem to be solved.

To solve the foregoing problem, a novel multi-stage LED driving circuit is needed.

### SUMMARY OF THE INVENTION

One objective of the present invention is to disclose a multi-stage LED driving circuit, which is capable of automatically adjusting the changing times of a dynamic LED load to eliminate the phenomena of current undershoot.

Another objective of the present invention is to disclose a multi-stage LED driving circuit, which is capable of resulting in an input current in phase with a line voltage to provide a high power factor.

Still another objective of the present invention is to disclose a multi-stage LED driving circuit, which is capable of effectively eliminating the phenomena of LED flickers.

To attain the foregoing objectives, a multi-stage LED driving circuit capable of eliminating current undershoot is proposed, including:

an LED module, having an input terminal and a plurality of stage output terminals, the input terminal being used for coupling with a line voltage;

a plurality of switch units, coupled with the stage output terminals to receive a plurality of branch currents and provide a plurality of current sensing signals;

a current regulation circuit, having a control end coupled with a variable reference voltage, and a current path for receiving the branch currents and generating a voltage signal at an input terminal of the current path; and

a control unit, receiving the current sensing signals and the voltage signal, and controlling the switch units;

wherein the control unit compares every two adjacent signals of the current sensing signals to get a ratio in turn to determine whether to switch off a corresponding switch unit of the switch units after a deferred time according to a comparison of the ratio with a predetermined ratio, and determines whether to change the deferred time according to a comparison of the voltage signal with a threshold voltage.

In one embodiment, the line voltage is a half-wave rectified voltage or a full-wave rectified voltage or a time varying voltage.

In one embodiment, the current regulation circuit includes a power transistor, a resistor, and an amplifier.

In one embodiment, the variable reference voltage is in phase with the line voltage.

In one embodiment, the variable reference voltage is a multi-stage voltage generated according to the line voltage.

To attain the foregoing objectives, another multi-stage LED driving circuit capable of eliminating current undershoot is proposed, including:

an LED module, including a plurality of sub LED modules connected in series and having an input terminal and a plurality of stage output terminals, the input terminal being used for coupling with a line voltage of a full-wave rectified waveform, a half-wave rectified waveform, or a time varying waveform, and the stage output terminals are provided by output terminals of the sub LED modules;

a plurality of switch units, each having a first control end, a first channel, and a current sensing unit, the first channel being coupled with one of the stage output terminals to receive a branch current and direct the branch current to a common node, and the current sensing unit generating a sensing signal analog to the branch current so that the switch units provide a plurality of current sensing signals CS₁-CS_{M}, M being a positive integer;

a second power switch having a second control end, a second current input end, and a second current output end, the second current input end being coupled with the common node, and the second current output end being coupled to a reference ground via a resistor;

an amplifier having a positive input end, a negative input end, and an output end, the positive input end being coupled with a variable reference voltage, which is in phase with the line voltage, the negative input end being coupled with the second current output end of the second power switch, and the output end being coupled with the second control end of the second power switch; and

a control unit having a plurality of first analog input end, a second analog input end, and a plurality of control signal output ends, the first analog input ends being for receiving the current sensing signals CS₁-CS_{M}, the second analog input end being coupled with the common node to receive a voltage signal, and the control signal output ends being for outputting a plurality of control signals SW₁-SW_{M} to drive the first control ends of the switch units respectively;

wherein the control unit initially makes each of the control signals SW₁-SW_{M} exhibiting an active state to turn on each of the switch units, and then, when two adjacent current sensing signals CSⱼ and CSⱼ₊₁ of the current sensing signals CS₁-CS_{M} are detected to have a ratio CSⱼ/CSⱼ₊₁ smaller than K, j being a positive integer ranging from 1 to M−1, K being a positive real number greater than 1, makes a control signal SWⱼ of the control signals SW₁-SW_{M} exhibiting an inactive state after a deferred time to turn off a switch unit of the switch units that provides the current sensing signal CSⱼ, and after making the control signal SWⱼ exhibiting the inactive state, determines whether the voltage signal is lower than a threshold voltage so as to add an adjusting time to the deferred time when the voltage signal is lower than the threshold voltage, and keep the deferred time unchanged when the voltage signal is not lower than the threshold voltage.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates corresponding waveforms of a line voltage and a load current of a multi-stage LED driving circuit of prior art.

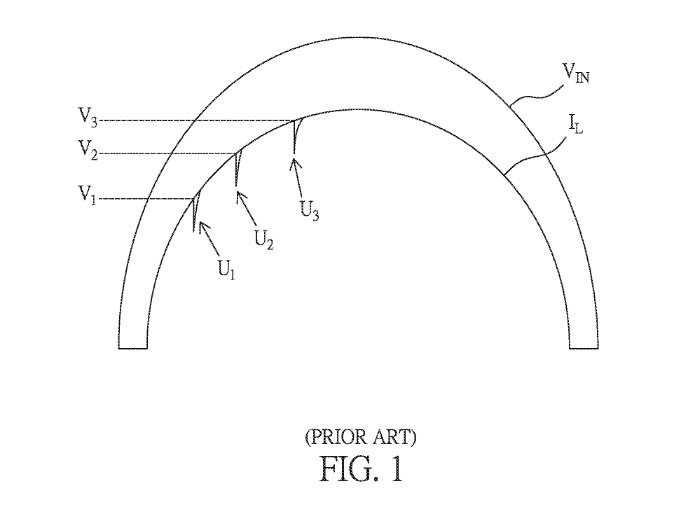

FIG. 2 illustrates a circuit diagram of a multi-stage LED driving circuit according to an embodiment of the present invention.

FIG. 3 illustrates a circuit diagram of a multi-stage LED driving circuit according to another embodiment of the present invention.

### DETAILED DESCRIPTION OF THE PREFERRED EMBODIMENTS

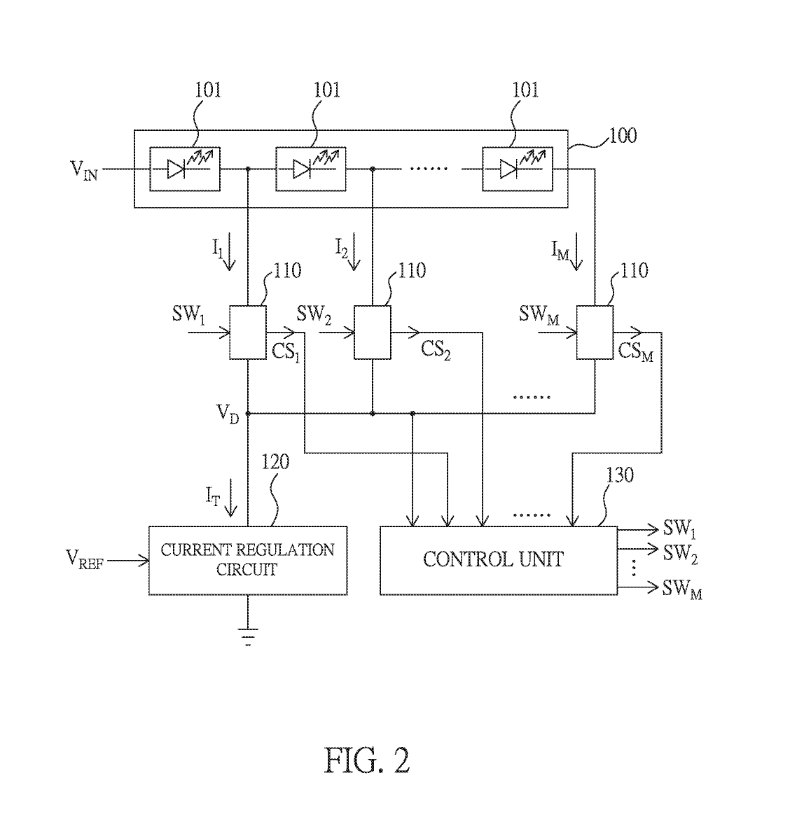

Please refer to FIG. 2, which illustrates a circuit diagram of a multi-stage LED driving circuit according to an embodiment of the present invention. As illustrated in FIG. 2, the multi-stage LED driving circuit includes an LED module 100, a plurality of switch units 110, a current regulation circuit 120, and a control unit 130.

The LED module 100 has a plurality of sub LED module 101, an input terminal, and a plurality of stage output terminals, wherein the sub LED module 101 has at least one LED, the input terminal is used for coupling with a line voltage V_{IN}, the stage output terminals are coupled with the switch units 110, and the line voltage V_{IN} can be a DC (direct current) voltage, a half-wave rectified voltage or a full-wave rectified voltage of an AC (alternating current) power, or a time varying voltage.

The switch units 110 are coupled with the stage output terminals so as to receive a plurality of branch currents I₁-I_{M} under the control of a plurality of control signals SW₁-SW_{M}, and provide a plurality of current sensing signals CS₁-CS_{M}, M being a positive integer.

The current regulation circuit 120 has a control end coupled with a variable reference voltage V_{REF}, and a current path for receiving a total current I_{T} of the branch currents I₁-I_{M} and generating a voltage signal V_{D} at an input terminal of the current path. The current regulation circuit 120 can include a power transistor, a resistor, and an amplifier, and the variable reference voltage V_{REF} can be in phase with the line voltage V_{IN} or be a multi-stage voltage generated according to the line voltage V_{IN}.

The control unit 130 receives the current sensing signals CS₁-CS_{M} and the voltage signal V_{D}, and controls the switch units 110, wherein the control unit 130 compares every two adjacent signals of the current sensing signals CS₁-CS_{M} to get a ratio in turn to determine whether to switch off a corresponding switch unit of the switch units 110 after a deferred time according to a comparison of the ratio with a predetermined ratio, and determines whether to change the deferred time according to a comparison of the voltage signal V_{D} with a threshold voltage.

During the period when the line voltage V_{IN} is increasing, the ratio Iⱼ/Iⱼ₊₁ of two adjacent branch currents and Iⱼ₊₁ will be decreasing accordingly, and when the ratio Iⱼ/Iⱼ₊₁ falls below a predetermined ratio value, the present invention determines that the line voltage V_{IN} has reached a level and a corresponding switch unit 110 of the branch current should be switched off accordingly. After the corresponding switch unit 110 is switched off, the present invention uses a threshold voltage to compare with the voltage signal V_{D}. If the voltage signal V_{D} is lower than the threshold voltage, it means that the corresponding switch unit 110 is switched off too early and the level of the line voltage V_{IN} in the meanwhile is not high enough to drive the LED load formed after the corresponding switch unit 110 is switched off, and the present invention will add an adjusting time to the deferred time; if the voltage signal V_{D} is higher than the threshold voltage, it means that the level of the line voltage V_{IN} is high enough to drive the LED load formed after the corresponding switch unit 110 is switched off, and the present invention will keep the deferred time unchanged.

When the (M−1)-th switch unit 110 is switched off, it means that the line voltage V_{IN} is about to reach a peak and become decreasing. During the period when the line voltage V_{IN} is decreasing, the present invention uses the threshold voltage to compare with the voltage signal V_{D} and switch on the (M−1)-th to first switch units 110 at respective instances when the voltage signal V_{D} is lower than the threshold voltage.

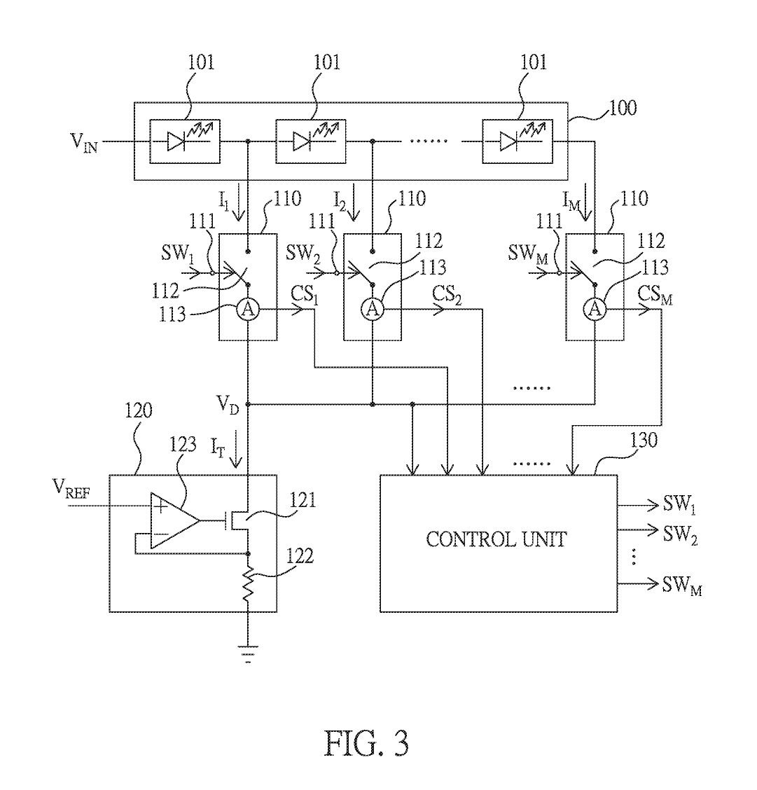

Please refer to FIG. 3, which illustrates a circuit diagram of a multi-stage LED driving circuit according to another embodiment of the present invention. As illustrated in FIG. 3, the multi-stage LED driving circuit includes an LED module 100, a plurality of switch units 110, a current regulation circuit 120, and a control unit 130.

The LED module 100 has a plurality of sub LED modules 101 connected in series, an input terminal, and a plurality of stage output terminals, wherein the input terminal is used for coupling with a line voltage V_{IN}, the line voltage V_{IN} can be of a full-wave rectified waveform or a half-wave rectified waveform or a time varying waveform, and the stage output terminals are provided by the output terminals of the sub LED modules 101.

Each of the switch units 110 has a first control end 111, a first channel 112, and a current sensing unit 113, the first channel 112 being coupled with one of the stage output terminals to receive a branch current Iⱼ, j being a positive integer ranging from 1 to M, the branch current flowing to a common node, and the current sensing unit 113 generating a sensing signal analog to the branch current so that the switch units 110 provide a plurality of current sensing signals CS₁-CS_{M}, M being a positive integer.

The current regulation circuit 120 includes a second power switch 121, a resistor 122, and an amplifier 123.

The second power switch 121 has a second control end, a second current input end, and a second current output end, the second current input end being coupled with the common node, and the second current output end being coupled to a reference ground via the resistor 122.

The amplifier 123 has a positive input end, a negative input end, and an output end, the positive input end being coupled with a variable reference voltage V_{REF}, which is in phase with the line voltage V_{IN}, the negative input end being coupled with the second current output end of the second power switch 121, and the output end being coupled with the second control end of the second power switch 121.

The control unit 130 has a plurality of first analog input end, a second analog input end, and a plurality of control signal output ends, the first analog input ends being for receiving the current sensing signals CS₁-CS_{M}, the second analog input end being coupled with the common node to receive a voltage signal V_{D}, and the control signal output ends being for outputting a plurality of control signals SW₁-SW_{M} to drive the first control ends 111 of the switch units 110 respectively.

When in operation, the control unit 130 initially makes each of the control signals SW₁-SW_{M} exhibiting an active state to turn on each of the switch units 110; then, when two adjacent current sensing signals CSⱼ and CSⱼ₊₁ of the current sensing signals CS₁-CS_{M} are detected to have a ratio CSⱼ/CSⱼ₊₁ smaller than K, j being a positive integer ranging from 1 to M−1, K being a positive real number greater than 1, makes a control signal SWⱼ of the control signals SW₁-SW_{M} exhibiting an inactive state after a deferred time to turn off a switch unit of the switch units 110 that provides the current sensing signal CSⱼ, and after making the control signal SWⱼ exhibiting the inactive state, determines whether the voltage signal V_{D} is lower than a threshold voltage so as to add an adjusting time to the deferred time when the voltage signal V_{D} is lower than the threshold voltage, and keep the deferred time unchanged when the voltage signal V_{D} is not lower than the threshold voltage.

When the (M−1)-th switch unit 110 is switched off, it means that the line voltage V_{IN} is about to reach a peak and become decreasing. During the period when the line voltage V_{IN} is decreasing, the present invention uses the threshold voltage to compare with the voltage signal V_{D} and switch on the (M−1)-th to first switch units 110 at respective instances when the voltage signal V_{D} is lower than the threshold voltage. Accordingly, the present invention can automatically adjust the changing times of a dynamic LED load, and thereby eliminate the phenomena of flickers.

Thanks to the designs disclosed above, the present invention offers the advantages as follows:

1. The multi-stage LED driving circuit of the present invention can automatically adjust the changing times of a dynamic LED load to eliminate the phenomena of current undershoot.

2. The multi-stage LED driving circuit of the present invention can result in an input current in phase with a line voltage to provide a high power factor.

3. The multi-stage LED driving circuit of the present invention can effectively eliminating the phenomena of LED flickers.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A multi-stage LED driving circuit capable of eliminating current undershoot, including:
an LED module, having an input terminal and a plurality of stage output terminals, the input terminal being used for coupling with a line voltage;
a plurality of switch units, coupled with the stage output terminals to receive a plurality of branch currents and provide a plurality of current sensing signals;
a current regulation circuit, having a control end coupled with a variable reference voltage, and a current path for receiving the branch currents and generating a voltage signal at an input terminal of the current path; and
a control unit, receiving the current sensing signals and the voltage signal, and controlling the switch units;
wherein the control unit compares every two adjacent signals of the current sensing signals to get a ratio in turn to determine whether to switch off a corresponding switch unit of the switch units after a deferred time according to a comparison of the ratio with a predetermined ratio, and determines whether to change the deferred time according to a comparison of the voltage signal with a threshold voltage.

2. The multi-stage LED driving circuit capable of eliminating current undershoot as in claim 1, wherein the line voltage is a half-wave rectified voltage or a full-wave rectified voltage or a time varying voltage.

3. The multi-stage LED driving circuit capable of eliminating current undershoot as in claim 1, wherein the current regulation circuit includes a power transistor, a resistor, and an amplifier.

4. The multi-stage LED driving circuit capable of eliminating current undershoot as in claim 1, wherein the variable reference voltage is in phase with the line voltage.

5. The multi-stage LED driving circuit capable of eliminating current undershoot as in claim 1, wherein the variable reference voltage is a multi-stage voltage generated according to the line voltage.

6. A multi-stage LED driving circuit capable of eliminating current undershoot, including:
an LED module, including a plurality of sub LED modules connected in series and having an input terminal and a plurality of stage output terminals, the input terminal being used for coupling with a line voltage of a full-wave rectified waveform, a half-wave rectified waveform, or a time varying waveform, and the stage output terminals are provided by output terminals of the sub LED modules;
a plurality of switch units, each having a first control end, a first channel, and a current sensing unit, the first channel being coupled with one of the stage output terminals to receive a branch current and direct the branch current to a common node, and the current sensing unit generating a sensing signal analog to the branch current so that the switch units provide a plurality of current sensing signals CS₁-CS_{M}, M being a positive integer;
a second power switch having a second control end, a second current input end, and a second current output end, the second current input end being coupled with the common node, and the second current output end being coupled to a reference ground via a resistor;
an amplifier having a positive input end, a negative input end, and an output end, the positive input end being coupled with a variable reference voltage, which is in phase with the line voltage, the negative input end being coupled with the second current output end of the second power switch, and the output end being coupled with the second control end of the second power switch; and
a control unit having a plurality of first analog input end, a second analog input end, and a plurality of control signal output ends, the first analog input ends being for receiving the current sensing signals CS₁-CS_{M}, the second analog input end being coupled with the common node to receive a voltage signal, and the control signal output ends being for outputting a plurality of control signals SW₁-SW_{M} to drive the first control ends of the switch units respectively;
wherein the control unit initially makes each of the control signals SW₁-SW_{M} exhibiting an active state to turn on each of the switch units, and then, when two adjacent current sensing signals CSⱼ and CSⱼ₊₁ of the current sensing signals CS₁-CS_{M} are detected to have a ratio CSⱼ/CSⱼ₊₁ smaller than K, j being a positive integer ranging from 1 to M−1, K being a positive real number greater than 1, makes a control signal SWⱼ of the control signals SW₁-SW_{M} exhibiting an inactive state after a deferred time to turn off a switch unit of the switch units that provides the current sensing signal CSⱼ, and after making the control signal SWⱼ exhibiting the inactive state, determines whether the voltage signal is lower than a threshold voltage so as to add an adjusting time to the deferred time when the voltage signal is lower than the threshold voltage, and keep the deferred time unchanged when the voltage signal is not lower than the threshold voltage.
